(19) United States
(12) Patent Application Publication
(10) Pub. No.: US 2007/0089330 A1
(43) Pub. Date: Apr. 26, 2007

(54) Identification, monitoring system as well as method for tracking the path of transport of a piece of luggage

(76) Inventors: Dirk Lehmann, Winsen (DE); Jorg Schauland, Hamburg (DE)

Correspondence Address: Friedrich Kueffner, Suite 910, 317 Madison Avenue, New York, NY, 10017, US

(21) Appl. No.: 11/546,520

(22) Filed: Oct. 10, 2006

(30) Foreign Application Priority Data
Oct. 10, 2005 (DE) 20 2005 015 972.7
Nov. 15, 2005 (EP) 05 024 891.3

(51) Int. Cl. G09F 3/20

(52) U.S. Cl. 40/6

(57) ABSTRACT

In order to improve the transport process of at least one piece of luggage and/or of at least one receptacle which transports the piece of luggage from a starting place, in particular from a check-in counter or from a loading point to a target place, in particular to a cabin of a passenger ship and/or inversely in such a manner that the loading and unloading of the piece of luggage and/or of the receptacle can take place reliably and quickly, it is proposed to fix at least one identification (10) for tracking the path of transport of the piece of luggage (15, 16, 17) from a starting place (25) to the target place (37) on the piece of luggage (15, 16, 17) and/or on the receptacle (40) which transports the piece of luggage (15, 16, 17).

### TECHNICAL FIELD

This invention relates to the transport process of at least one piece of luggage and/or of at least one receptacle which transports the piece of luggage from a starting place, in particular from a check-in counter or from a loading point to a target place, in particular to a cabin of a passenger ship and/or inversely, in particular this invention relates to the transport of luggage to and from a ship.

### PRIOR ART

Passenger ships can easily transport 2500 to 6000 passengers and more who are lodged in cabins within a deck. The transport of luggage to a ship or from a ship constitutes a relatively big problem with respect to the size of the existing passenger ships and of those which are being built.

Luggage must be brought onto a ship or from a ship as quickly as possible and on the other hand the luggage must be transported safely and without being mixed up in front of the right cabin as well as back from the cabin to the terminal after termination of the trip, all the more since the passenger generally takes over his luggage in the terminal.

### Presentation of the Invention: Aim, Solution, Advantages

Starting from the disadvantages and insufficiencies explained above as well as by paying tribute to the outlined prior art, the aim of this invention is to improve the above indicated transport process of a piece of luggage and/or of the receptacle which transports the piece of luggage in such a manner that the loading and unloading of the piece of luggage and/or of the receptacle can take place reliably and quickly.

This aim is achieved by an identification with the characteristics indicated in claim 1, by a monitoring system with the characteristics indicated in claim 6 as well as by a method with the characteristics indicated in claim 9. Advantageous embodiments and appropriate improvements of this invention are characterized in the respective subclaims.

According to the invention, the tracking of the path of transport of the piece of luggage is carried out from the starting place to the target place by means of at least one identification, whereby the identification can be fixed on the piece of luggage and/or on at least one receptacle which transports the piece of luggage.

In order to be able to track the path of transport of the piece of luggage, according to an advantageous embodiment of this invention, the identification can be detected in a computer at the starting place and/or at the target place.

Independently from this or additionally to this, the identification is advantageously detected in a computer in at least one station, preferably in each station situated between the starting place and the target place, for example at at least one intermediate station, for example in at least one customs post with security check and/or in at least one warehouse and/or in at least one lift and/or in at least one tweendeck.

The identification can be configured as at least one machine readable device and/or as at least one transponder unit.

An identification made of synthetic material has the advantage of a long service life with a relatively light weight.

Moreover, the identification is advantageously configured to receive data and/or information such as, for example, weight and/or cabin number and/or passenger name. The possibility of the storage of data and/or information by the identification is advantageous for example during the transport of the piece of luggage or of the receptacle which transports the piece of luggage by means of a luggage automation.

Appropriately, the data and/or information stored by means of the identification can be read-out at least partially by means of at least one reading unit, in particular by means of at least one transponder reading device.

Optionally the data and/or information can be evaluated at least partially by means of an evaluation unit, in particular by means of a processor unit.

Furthermore, the data and/or information stored by means of the identification and/or the data and/or information read-out by means of the reading unit and/or evaluated by means of the evaluating unit are represented at least partially by means of at least one display unit, in particular by means of at least one monitor.

The display unit can be for example a flat screen which is placed advantageously in the vicinity of the starting place and/or of the target place and/or the station situated between the starting place and the target place at which the identification is detected by a computer.

The receptacle which transports the piece of luggage can be configured as at least one device, in particular as a transport box or as a tub-shaped receptacle or a small container, for loading and unloading the piece of luggage for a passenger ship, in particular a cruiser with ship cabins in ship decks.

This being, the receptacle is designed to transport the respective piece of luggage of the single ship cabins from the starting place outside the ship to at least one station situated between the starting place and the target place or to the target place and/or in reverse direction.

The luggage organization is considerably facilitated and accelerated by the solution according to the invention. A loading and unloading can take place even just-in-time.

Thus, for example a passenger of a sea passage must not wait a long time for his luggage if the pieces of luggage and/or the receptacle which transports the pieces of luggage are marked by means of the identification according to the invention for the transport of the pieces of luggage to the ship to the cabin booked by the passenger.

Furthermore, this invention allows the tracking of the piece of luggage and/or the receptacle marked with the respective identification for the duration of the whole trip. This is particularly helpful for ship travels for which the piece of luggage and/or the receptacle, after the piece of luggage having been unpacked in the cabin, is stored in a luggage storeroom and is thus in the cabin of the passenger only during packing and unpacking.

Furthermore, it is avoided that the passenger must put his luggage in front of the door of his cabin on the day preceding the day of the checking-out and thus has no occasion any longer to stow away in the suitcase festive dress which has eventually been worn.

Advantageously the identification is easily visible and has in particular an outstanding shape and/or configuration. This has the advantage that the passenger must no longer search for his luggage for example at a luggage delivery place. Due to the easily visible identification on the receptacle and/or on the piece of luggage, it can also be safely avoided that the passenger takes a wrong piece of luggage in case of similar or alike looking pieces of luggage.

The identification of the pieces of luggage by means of the identification also facilitates the association of the pieces of luggage with the target place, for example with the respective cabin or the respective ship deck. Advantageously, the identification is configured such that, due to its shape and/or configuration and/or due to the data stored, it can be clearly associated with the target place of the allocated receptacle or of the allocated receptacle.

Finally, this invention relates to the use of at least one identification according to the type presented above and/or at least one monitoring system according to the type presented above and/or a method according to the type presented above for detecting the respective position, in particular the respective place of storage or of the respective location of the piece of luggage and/or of the receptacle which transports the piece of luggage, in particular during the transport of the piece of luggage and/or of the receptacle by means of at least one automatized transport system, for example by means of at least one luggage automation.

### SHORT DESCRIPTION OF THE DRAWINGS

As already discussed above, there are various possibilities to configure and improve the teachings of this invention. For this purpose, it is referred on the one hand to the claims referring to claim 1 as well as to those referring to claim 6, on the other hand further embodiments, characteristics and advantages of this invention are explained in detail below by means of the embodiment illustrated by the FIGS. 1 and 2.

FIG. 1 shows a schematic representation of an embodiment for a monitoring systems according to this invention which works according to the method according to this invention.

FIG. 2 shows a schematic representation of the monitoring systems of FIG. 1 in a station situated between the starting place and the target place.

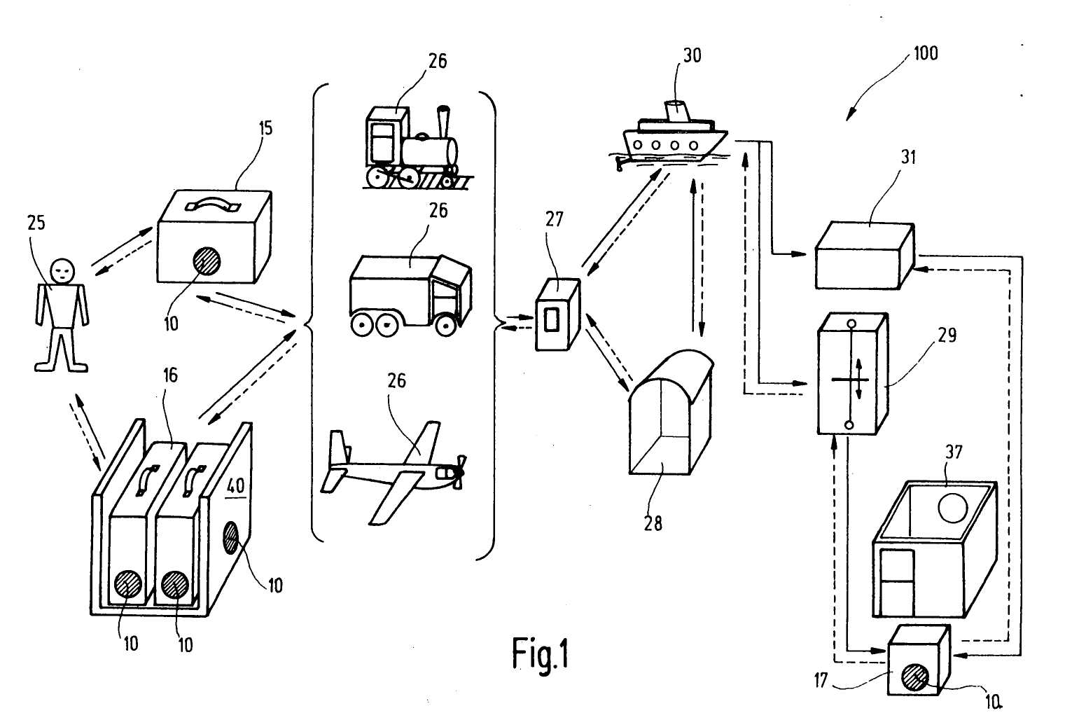

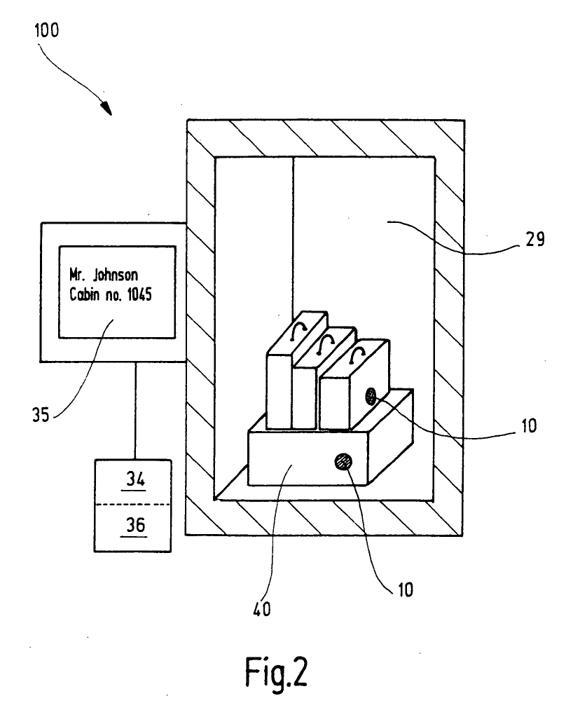

The same or similar configurations, elements or characteristics are provided with identical reference numerals in FIG. 1 and 2.

### BEST WAY FOR CARRYING OUT THE INVENTION

FIG. 1 shows a preferred embodiment of this invention, in particular the tracking of pieces of luggage 15, 16, 17 from a starting place 25, namely a loading point, to a target place 37, namely to a cabin 37 of a passenger ship.

As can be seen in FIG. 1, single pieces of luggage 15, 16 and a receptacle 40 which transports pieces of luggage 16 are first transported from the loading point 25, for example by means of at least one transport means 28, for example by means of a conveyor belt or by train, truck or airplane, to a first intermediate station 27 situated between the starting place and the target place 37, namely to a customs station with safety check.

After customs clearance the piece of luggage 15, 16 and the receptacle 40 will be intermediately stored eventually in a second intermediate station 28 situated between the starting place 25 and the target place 37, namely a storehouse, and then transported to the passenger ship 30.

On the passenger ship 30 the piece of luggage 15, 15 and the receptacle 40 are eventually transported by means of a luggage lift 29 to the wished deck 31 of the passenger ship 30, for example to the tweendeck, and from there to the target place, namely to the wished cabin 37.

In order to be able to track the path of transport of the luggage piece 15, 16, 17, it is essential that the respective single pieces of luggage 15, 16, 17 and/or the receptacle 40 are provided from the beginning on with identifications 10.

These identifications 10 can be detected by a computer in each intermediate station 27, 28, 29, 31 situated between the starting place 25 and the target place 37 which is represented in the detail view of FIG. 2 with the example of the intermediate station of the luggage lift 29.

The identifications 10 can be machine readable devices or transponders or the like which are configured to store data and/or information, as for example weight and/or cabin number and/or passenger name.

For reading the data and/or information stored by means of the identification 10, the monitoring system 100 represented in FIG. 2 has preferably in each station in which the identification 10 is detected by a computer, thus for example at the starting place 25, in the intermediate stations 27, 28, 29, 31 and at the target place 37, respectively one reading unit 38, for example a transponder reading device.

Moreover, the monitoring system 10 has, preferably in each station 25, 27, 28, 31, 37, at least one evaluating unit 34, in particular at least one processor, for evaluating the data and/or information read-out by means of the reading unit 36 for the computer detection of the identifications 10.

Furthermore, the monitoring system 100 has preferably in each station 25, 27, 28, 31, 37, in which the identification is detected by a computer, one display unit 35, in particular a flat screen monitor for representing the data and/or information read-out by means of the reading unit 36 and/or by means of the evaluating unit 34.

Thus, each location of the respective pieces of luggage 15, 16, 17 as well as of the receptacle 40 can be detected by means of the monitoring system 100.

The reading unit 36, the evaluating unit 34 and the display unit 35 which are represented in the detail view of FIG. 2 are not represented in FIG. 1 for reasons of clarity.

In short, this invention proposes to arrange an identification 10 for tracking the path of transport of the piece of luggage 15, 16, 17 from the starting place 25 to the target place 37 on the piece of luggage 15, 16, 17 and/or on the receptacle 40 which transports the piece of luggage 15, 16, 17 in order to improve the transport process of the piece of luggage 15, 16, 17 and/or of the receptacle 40 which transports the piece of luggage 15, 16, 17 from the starting place 25 to the target place 37 and/or inversely so that a loading and unloading of the piece of luggage 15, 16, 17 and/or of the receptacle 40 which transports the piece of luggage 15, 16, 17 can take place reliably and quickly.

This invention is not only limited to the embodiments which are represented and described but can comprise other identifications or monitoring systems which fulfill the same purpose.

### List of reference numerals

10 Identification, in particular machine readable device and/or transponder unit
15, 16, 17 Pieces of luggage
25 Starting place, in particular check-in counter ot loading place
26 Transport means, in particular train, motor vehicle or airplane, for transporting the pieces of luggage 15, 16, 17 from the starting place 25 to at least one station 27, 28, 29, 31
27 Station (first) between starting place 26 and target place 37, in particular customs station with safety check
28 Further station (second) between starting place 25 and target place (37), in particular storehouse
29 Further station (third) between starting place 25 and target place 37, in particular luggage lift, for example lift of a ship
30 Ship, in particular passenger ship
31 Further station (fourth) between starting place 25 and target place 37, in particular tween deck of a ship
34 Evaluating unit, in particular processor
35 Monitor display monitor
36 Reading unit, in particular transponder reading device
37 Target place, in particular cabin of a passenger ship
40 Receptacle, in particular transport box or tub-shaped receptacle or small container
100 Monitoring system

1. Identification (10) for tracking at least one piece of luggage (15, 16, 17) from a starting place (25), in particular from a check-in counter or from a loading point to a target place (37), in particular to a cabin of a passenger ship, whereby the identification (10) can be fixed on the piece of luggage (15, 16, 17) and/or on at least one receptacle (40) which transports the piece of luggage (15, 16, 17).

2. Identification according to claim 1, wherein the identification (10) can be detected by a computer, in particular
at the starting place (25) and/or
in at least one station (27, 28, 29, 31) situated between the starting place (25) and the target place (37), for example in at least one intermediate station, for example in at least one customs station with safety check and/or a storehouse and/or in at least one lift and/or in at least one tweendeck and/or
at the target place (37).

3. Identification according to claim 1, wherein the identification (10) is configured as at least one machine readable device and/or as at least one transponder unit.

4. Identification according to claim 1, wherein the identification (10) is configured to receive data and/or information such as, for example, weight and/or cabin number and/or passenger name and/or is clearly visible, in particular has an outstanding shape and/or configuration.

5. Identification according to claim 1, wherein the receptacle (40) is configured
as at least one device, in particular as a transport box or as a tub-shaped receptacle or a small container, for loading and unloading the piece of luggage (15, 16, 17) for a passenger ship, in particular a cruiser with ship cabins in ship decks and
is designed to transport the respective piece of luggage (15, 16, 17) of the single ship cabins from the starting place (25) outside the ship
to at least one station (27, 28, 29, 31) situated between the starting place (25) and the target place (37), for example to at least one intermediate station, for example to at least one customs station with safety check and/or to at least one storehouse and/or to at least one lift and/or to at least one tweendeck or
to the target place (37) and/or inversely.

6. Monitoring system (100) for tracking the path of transport of at least one piece of luggage (15, 16, 17) from a starting place (25), in particular from a check-in counter or a loading point, to a target place (37), in particular to a cabin of a passenger ship which has
at least one identification (10) according to claim 1 and
at least one reading unit (36), in particular at least one transponder reading device, for reading-out at least one part of the data and/or information stored by means of the identification (10).

7. Monitoring system according to claim 6, comprising at least one evaluating unit (34), in particular at least one processor for evaluating at least one part of the data and/or information read-out by means of the reading unit 36.

8. Monitoring system according to claim 6, comprising at least one display unit (35), in particular at least one monitor, for displaying at least one part of the data and/or information read-out by means of the reading unit (36) and/or evaluated by means of the evaluating unit (34).

9. Method for tracking the path of transport of at least one piece of luggage (15, 16, 17) from a starting place (25), in particular from a check-in counter or from a loading point to a target place (37), in particular to a cabin of a passenger ship, whereby he piece of luggage (15, 16, 17) and/or at least one receptacle (40) which transports the piece of luggage is provided at the starting place (25) with at least one identification (10), in particular according to claim 1.

10. (canceled)
